(19) United States
(12) Patent Application Publication
(10) Pub. No.: US 2023/0204511 A1
(43) Pub. Date: Jun. 29, 2023

(54) TIME-RESOLVING HYPERSPECTRAL IMAGING SPECTROSCOPY

(71) Applicant: Research Instruments Corporation, Barrington, RI (US)

(72) Inventor: BERNHARD WERNER ADAMS, NAPERVILLE, IL (US)

(21) Appl. No.: 17/996,489

(22) PCT Filed: Apr. 19, 2021
(86) PCT No.: PCT/US2021/027883

§ 371 Date: Oct. 18, 2022

Related U.S. Application Data
(60) Provisional application No. 63/104,972, filed on Oct. 23, 2020.
(60) Provisional application No. 63/067,698, filed on Aug. 19, 2020.
(60) Provisional application No. 63/012,217, filed on Apr. 19, 2020.

(51) Int. Cl. G01N 21/64; G02B 21/00

(52) U.S. Cl. CPC G01N 21/6408; G01N 21/6458; G02B 21/0076

(57) ABSTRACT

A method of fluorescence spectroscopy includes providing a high-performance sensor that combines imaging with high intrinsic time resolution and high-rate capability, and resolving fluorescence data in four dimensions.

### CROSS REFERENCE TO RELATED APPLICATIONS

This application claims benefit from U.S. Provisional Patent Application Ser. No. 63/012,217, filed Apr. 19, 2020, U.S. Provisional Patent Application Ser. No. 63/067,698, filed Aug. 19, 2020, and U.S. Provisional Patent Application Ser. No. 63/104,972, filed Oct. 23, 2020, each of which is incorporated by reference in its entirety.

### BACKGROUND OF THE INVENTION

The present invention relates generally to fluorescence spectroscopy, and more particularly to Time-resolving Hyperspectral Imaging Spectroscopy (THIS).

In general, spectroscopic methods are popular in bio-medical and physico-chemical research because they can deliver rapid results and can be repeated multiple times without requiring the addition of fresh reagents each time, or even at all. Among the spectroscopic methods, Fluorescence-Lifetime Imaging Microscopy (FLIM) is often used because it yields detailed fingerprint-like information on both the identity, and the chemical activity of target molecules. In FLIM, the sample molecules are excited to fluorescence by light that is pulsed or otherwise modulated in time. Following the absorption of a photon, a molecule typically undergoes a sequence of relaxation processes where some of the photon's energy is dissipated and goes into molecular vibrations and other lower-energy degrees of freedom. At various steps along the relaxation cascade, the remaining energy may be emitted in the form of a photon, or it may be transferred to a neighboring molecule in a process known as Förster Resonant Energy Transfer (FRET). The latter occurs only across small distances of less than about 10 nanometers, and is therefore an indicator of the proximity of the photon-absorbent to the fluorescence-emitting molecule.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features a method of fluorescence spectroscopy including providing a high-performance sensor that combines imaging with high intrinsic time resolution and high-rate capability, and resolving fluorescence data in four dimensions.

In another aspect, the invention features a method for rapidly performing a Fluorescence-Lifetime Imaging Microscopy measurement including engaging a sensor that delivers a continuous data stream of time-and-location-tagged light detection events, and at a high rate of many light-detection events within the fluorescent lifetime of the molecular species of interest.

In still another aspect, the invention features a system for performing imaging spectroscopy a detection sensor configured for detecting and providing a multidimensional data stream of time-tagged, location-tagged and/or wavelength-tagged detection events.

In another aspect, the invention features a system including an air duct for channeling a flow of air, the air including particles of a substance of interest, a pulsed laser beam configured to reflect off a pair of mirrors in a multiply-folded path that produces a sheet of light spanning a cross-section of the air duct, a lens, and a window, wherein fluorescent light generated within the sheet of light is imaged by the lens through the window onto a continuously-operating ultrafast-timing imaging detector with single-photon sensitivity in a visible and neighboring ultraviolet and infrared spectral regions.

In another aspect, the invention features a method including performing Fluorescence-Lifetime-Spectroscopy (FLS) measurements with a time-resolving imaging sensor continuously without time-gating or otherwise modulating a light sensitivity of the imaging sensor.

In yet another aspect, the invention features a method providing a mass-selecting, or a mass-dispersing mass spectrometer, or a time-of-flight mass spectrometer, in combination with THIS, where the latter provides structural and other chemical information on the mass-selected molecular species.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 is an exemplary simplified Jablonski energy-level diagram.

FIG. 2 is an exemplary FLIM experimental arrangement.

FIG. 3 is a three-dimensional representation of discretizing multidimensional data in at least one of its dimensions into slices, and multiplexing these slices into another of the data dimensions.

FIG. 4 is a four-dimensional representation of discretizing multidimensional data in at least one of its dimensions into slices, and multiplexing these slices into another of the data dimensions.

FIG. 5 shows a particular embodiment of the invention for realizing THIS.

FIG. 6 shows an air duct with a sheet of excitation light formed by reflecting a pulsed laser in a zig-zag path between a pair of mirrors.

FIG. 7 shows a simple laser-beam path forming a two-dimensional light sheet within which fluorescence excitation takes place.

FIG. 8 shows an example of an improved laser-beam path forming a light sheet that avoids the problem of double excitation within the fluorescent lifetime.

FIG. 9 shows a 3D view of the baffles and the air stream protecting a mirror from deposition of foreign substances on its surface.

FIG. 10 shows a 2D view from above with the mirror inside the baffles and the air flow flushing foreign substances away from it.

FIG. 11 shows a schematic view of the optics used for wavelength resolution with a transmission grating sending part of the light to the 0-th order for a direct and undispersed image, while the 1st order is dispersed by wavelength.

FIG. 12 shows how the 0-th order and the 1st order of the polychromatic light from a fluorescent molecule are mapped onto the CUTID.

FIG. 13 shows 3D data (1D spatial, wavelength, time) multiplexed into two dimensions.

FIG. 14 shows an air duct with a laminar flow of air carrying a fluorescent particle from the light sheet to a cross-sectional plane, as well as a suction hose for capturing samples, whose input aperture is positioned in the air stream according to the detected position of a particle of interest.

FIG. 15 shows a mass spectrometer tuned to select certain mass species, depositing these mass species on a substrate where they are then analyzed further with optical spectroscopy, preferably by time-resolved hyperspectral imaging spectroscopy (THIS).

FIG. 16 shows a mass spectrometer that disperses molecules and spreads them according to their masses along a spatial coordinate. These molecules are deposited onto a substrate and then analyzed further with optical spectroscopy, preferably THIS.

FIG. 17 shows a time-of-flight mass spectrometer that separates mass species by velocity and thus at each instant in time by position along the flight path. Optical spectroscopy, preferably THIS, is performed on these molecules in-flight.

FIG. 18 shows an orbitrap mass spectrometer where optical spectroscopy, preferably THIS, is performed in-flight on the molecules orbiting inside the trap.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

Fluorescence lifetime imaging microscopy (FLIM) is a non-invasive technique in which an image of a fluorescent probe or marker can be obtained in a cell without compromising or damaging the cell. The combination of scanning laser beams and powerful computers has advanced the field rapidly over the past 20 years. Fluorescence characteristics such as wavelength, lifetime and polarization can now be recorded relatively easily and quickly.

Fluorescence is a type of luminescence, i.e., light generated following the absorption of light (photon) by a suitable molecule (fluorophore). Typically, the molecule is an organic dye, such as fluorescein, which has delocalized electrons. Intrinsic biological molecules, including amino acids such as tryptophan, also fluoresce.

In FIG. 1, an exemplary simplified Jablonski energy-level diagram 10 of a fluorophore is shown. Here, the thick black lines represent electronic energy levels and the thin black lines represent vibrational energy levels. On absorption (blue arrow), the molecule moves from its ground electronic state (S0) to an excited, unstable, electronic state (S1), which decays back to the ground state either by:

(1) a radiative process, by emitting photons—e.g., from S1, which is seen as fluorescence (on timescales of the order of 10⁻⁹ s, and shown as the green arrow), or via a triplet state (T₁), which occurs on a longer timescale (seconds) and is seen as phosphorescence (red arrow); or

(2) via non-radiative processes as heat (vibrations), which is shown as dashed lines, or intersystem crossing (solid curly arrow).

In a typical FLIM experiment, a laser beam is scanned across a sample under a microscope and the fluorescence is measured as a function of the position on the sample. The fluorescence lifetime provides the contrast of the image, which is the basis of fluorescence lifetime imaging.

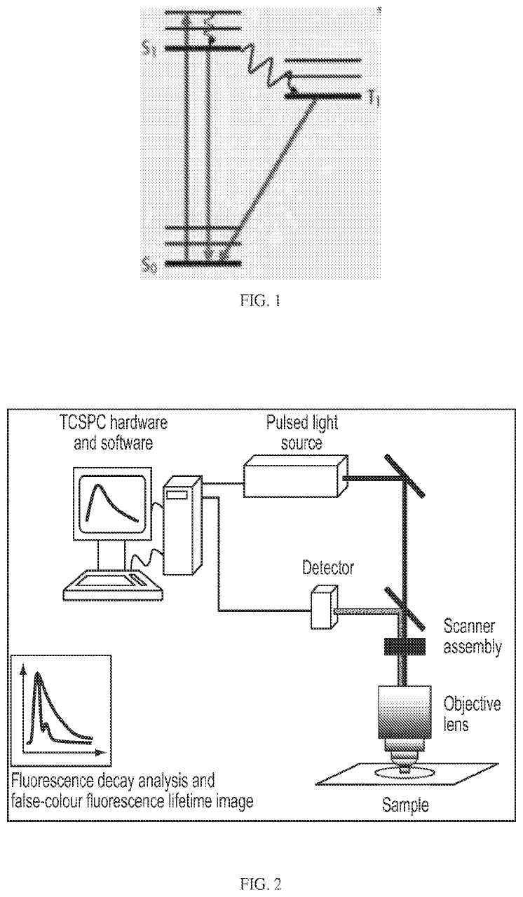

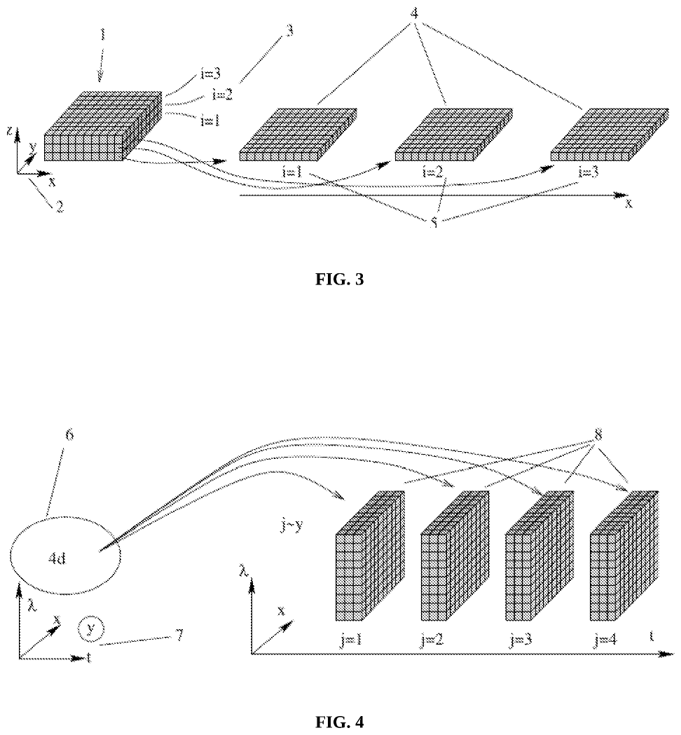

In FIG. 2, an exemplary FLIM experimental arrangement 200 is illustrated. A pulsed laser is used to excite a sample, which is mounted on a stage of a laser-scanning confocal microscope. The confocal microscope provides better depth resolution than a standard microscope because it has a pinhole in the beam path which blocks all out-of-focus light. The fluorescence passes back through the objective lens before it is spectrally separated from the excitation light using a dichroic beam splitter (mirror) and is detected using, for example, a photomultiplier tube or photodiode.

The decay of fluorescence for most biologically important fluorophores typically occurs on timescales on the order of several nanoseconds (1 ns=10⁻⁹ s). To measure the decay it is therefore essential to use pulses of excitation light which are shorter than the decay time of the fluorophore. Pulsed lasers with picosecond (1 ps=10⁻¹² s) or femtosecond (1 fs=10⁻¹⁵ s) pulse duration are used. The emitted fluorescence photons are detected using time-correlated single photon counting (TCSPC), which measures the time between the excitation pulse and the arrival of each individual fluorescence photon. A histogram is built up to show the number of fluorescence photons arriving within a given time interval. This curve is, typically, fitted to a multi-exponential decay to obtain the fluorescence lifetimes.

FLIM measures the fluorescence decay in each pixel of an image. A typical representation of the data is to determine, for each pixel, a characteristic lifetime (τ_{f}), and then creating a FLIM image by assigning a false color scale to the lifetime, e.g., the shortest detected lifetime is assigned a blue color and the longest lifetime is assigned red, with a range of colors for intermediate lifetimes.

The present invention improves on Fluorescence-Lifetime Imaging Microscopy both quantitatively and qualitatively. The quantitative improvement lies in a high efficiency and throughput. Qualitative improvements include a reduction of possible sample damage from optical excitation due to optimal use of fluorescent light, and, more importantly, an extension of the underlying technique by resolving both the time dependence of fluorescence, as well as the spectral shifts over time. This additional wavelength-spectral dimension in the data results in higher specificity in sample-species identification and determination of chemical activity. Both quantitative, and qualitative improvements are enabled by a photon-sensor technology that combines imaging with ultra-fast timing resolution at high photon detection event rates.

The present invention uses the time dependence of fluorescence following pulsed, or otherwise modulated optical excitation. This time dependence is used in FLIM, which obtains its molecule specific signatures from the time constants of multi-exponential fluorescence decay indicative of internal molecular relaxation pathways following the initial photonic excitation. These relaxation pathways are not only molecule-specific, but are also influenced by the chemical environment, in particular the presence of next neighbor complex molecules. Therefore, for example in biological contexts, FLIM provides information not only on the presence, but also on enzymatic activity or cellular signaling, and so forth. For all its power, FLIM in practice provides much less detail and is much less efficient than would be theoretically possible. This discrepancy is largely due to limitations of available light sensors for detecting the fluorescence. Imaging sensors used previously in FLIM do not possess a high intrinsic time resolution combined with faculties for a high photon-detection-rate, and sensors that do combine these capabilities are not imaging. Due to these limitations, the acquisition of FLIM images requires a time-consuming scan of a timing parameter such as a time gate or modulation phase, or operation at low photon flux to stay within the parameters of a low-rate sensor. FLIM also does not record spectral shifts during the time of fluorescent decay, which contain valuable additional information for discriminating between molecular species and activities.

The present invention improves FLIM in at least two distinct ways. The first is a quantitative and qualitative improvement due to a use of a high-performance sensor that combines imaging with high intrinsic time resolution and high-rate capability. The second is an implementation of a new technique, hereinafter referred to as Time-resolving Hyperspectral Imaging Spectroscopy (THIS), which resolves the fluorescence data in four dimensions (2D image, time, and wavelength spectrum) instead of three, as in conventional FLIM (2D image, time, but integrated over the wavelength).

Using a photon sensor that provides a continuous data stream of time- and image location-tagged photon-detection events eliminates a need for time-gating or otherwise modulating the sensitivity, as well as time-consuming scans of such gating or modulation phase. This feature amounts to a quantitative improvement by directly reducing the image-acquisition time. Another quantitative improvement lies in the optimal use of all photons on the sensor without losing any to sensitivity modulation. This is, at the same time, a qualitative improvement with samples that are susceptible to bleaching or damage from the excitation light because it enables a reduction in sample-excitation dose for a given required amount of detected light.

In order to fully characterize the relaxation processes in a photo-excited molecule, and thus identify it, and gain insights into its chemical activity, one needs to measure both the temporal and the spectral details, ideally to the quantum-uncertainty limit. In contrast, FLIM data, which are not spectrally resolved, are ambiguous to spectral differences. Resolution of spectral details in THIS is enabled by the same performance features in the sensor that also improve conventional FLIM.

The present invention overcomes the limitations of commonly used sensors in FLIM by using an imaging-capable sensor that has intrinsically high time resolution while also operating at high rates and at single-photon sensitivity. With the sensor recording all photons after a pulsed event, no scan of time gate or detector-response phase is necessary, and the data are simultaneously of time- and of frequency-domain type. The distinction between the domains becomes then purely one of how the data are processed. Currently, an example sensor technology that enables such operation is known as the Large-Area Picosecond Photodetector (LAPPD™). However, the present invention can be realized equally well with any other sensor technology that provides photon-sensing events as a continuous, i.e., not gated or modulated, data stream at high rate. Such detectors are referred to herein as operating by Continuous Ultrafast Time-resolving Imaging Detection (CUTID).

A non-THIS FLIM system using CUTID technology differs from a conventional one only in the sensor itself and in the way that the data are recorded as a list of time- and image-location-tagged events. From such a list, one can extract the time-domain or frequency-domain data at will.

A THIS system based on CUTID makes use of the combined ultrafast time resolution and high-rate capability to time-multiplex a four-dimensional data set into three dimensions (2D spatial and time). This is possible because the data in the image and the spectral dimension are discretized into pixels and wavelength intervals while the data in the time dimension are captured only over finite intervals.

Successive data intervals in one of the discretized dimensions can then be mapped onto successive time intervals. In a representation, a 4-dimensional slab representing the data is disassembled and multiplexed into a finite number of three dimensional slabs.

THIS multiplexes one out of four data dimensions onto another one of these, namely time. This is possible because the time span of fluorescence decay is measured in nanoseconds, so successive time slices spaced on the microsecond scale are available for this multiplexing. A natural candidate for being discretized and multiplexed onto the time axis is one of the spatial dimensions of the sample, say y, because it lends itself to the operation of a scanner where the sample is moved rapidly through the field of view, creating a natural correlation between y and t.

FIG. 3 shows a 3-dimensional data set (1) with coordinates x, y, z (2) and discretized to volume elements (voxels) in a rectangular slab, converted to a sequence (3) with index i, of 2-dimensional x-y data (4) sets along the z dimension. Successive 2-dimensional x-y data (4) sets correspond to the index i (5) discretizing along z, and multiplexed along x.

FIG. 4 shows a 4-dimensional data set (6) with coordinates x, y, t, λ (7) discretized to 4-dimensional voxels in a rectangular slab, which is not shown explicitly due to the difficulty of drawing a 4-dimensional object. The data set is converted to a sequence (8), with index j for discrete slices of the data in y, of 3-dimensional x-λ-t data multiplexed along the t dimension. This principle can be applied to any 4-dimensional data set with appropriately chosen and discretized coordinates, and by analogous extension, also to higher-dimensional data sets. It shall be further explained here in the context of THIS, but that shall not be construed as limiting the broader claim of applicability. In THIS, the coordinates x, y refer to the spatial coordinate in the image of the sample, t is the time, and λ the wavelength of fluorescence. The 4-dimensional voxels contain the fluorescent intensity at sample location x, y, time t and at wavelength λ. The 4-dimensional data are discretized in the y direction and are multiplexed on the time axis in to 3-dimensional data sets of fluorescence over x, λ, t.

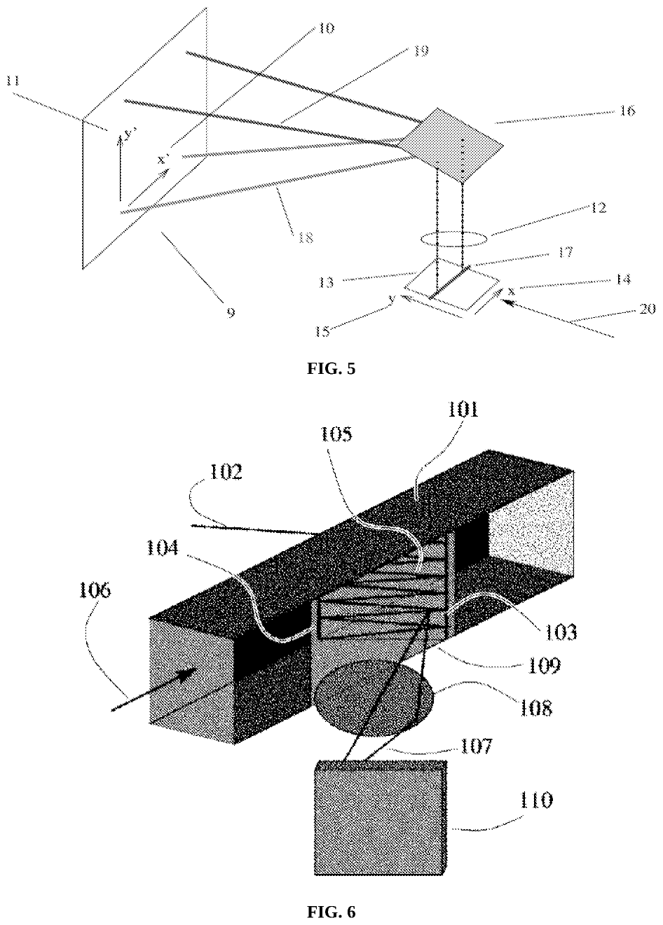

FIG. 5 shows an embodiment in which a CUTID (9) sensor with local coordinates x′ (10), y′ (11) is set up such that microscope lens (12) images from the sample plane (13) with coordinates x (14), y (15) onto the x′ (10), y′ (11) surface of the CUTID (9), via reflection from a diffraction grating (16). However, only the x′ dimension of the sensor corresponds to the x dimension of the sample while the y′ dimension of the sensor corresponds to fluorescence wavelength as resolved by the grating. The reason is that the sample is excited to fluorescence by a line focus (17) of the excitation light source, which is parallel to the x (14) direction, and which is imaged along the x′ (10) coordinate on the sensor while the diffraction grating (16) spreads the image into a spectrum indicated schematically by the fan from red (18) to blue (19) colors onto the y′ (11) coordinate on the sensor. Therefore, only a line within the image place actually emits fluorescent light. The colors red and blue are meant only to schematically indicate the wavelength spectrum and the direction of its spread with longer wavelengths being diffracted at larger angles. They are not meant to mean any actual wavelengths. The sample moves rapidly along the y (15) coordinate while the excitation light is pulsed at a rapid rate. The motion speed and pulse rate are matched such that each pulse excites a line on the sample adjacent to the previous one, which has moved on. Ideally, the width of the line focus (17) is matched to the resolution of the imaging system. Under these conditions, the fluorescence following each excitation pulse is resolved by the spatial resolution of the sensor with respect to the x (14) coordinate and the wavelength λ in the spectrum between the schematically indicated by the fan between red (18) and blue (19) colors. Furthermore, time t is resolved directly by the data recording. The sample coordinate y is discretized by the sample motion and successive excitation of adjacent lines, and is multiplexed in time, corresponding to the sequence (8) in FIG. 4 The coordinates x, y, t, λ correspond to coordinates x, y, t, λ (7) shown in FIG. 4.

In the embodiment shown in FIG. 5, the sample may be present on the surface of a tape that is pulled through the field of view of a microscope. The y (15) direction is aligned with the sample motion, and the x (14) direction is perpendicular to it. Sample excitation light from, for example, a picosecond pulsed laser is shaped into a line focus (17) aligned with x (14). The microscope lens (12) images the excitation line onto the CUTID (9) in its x′ (10) direction via reflection from the diffraction grating (16) such that the pertinent wavelength spread of the fluorescent spectrum fills the available range in the y′ (11) direction on the sensor. The width of the line focus (17) matches the spatial resolution of the imaging optics. The speed of the sample motion is kept below a threshold where the sample would move by more than the focal-line width within the time interval of interest for the fluorescent decay, i.e., typically up to about 100 ns in the case of proteins. The excitation pulse repeats at a rate such that an excitation occurs whenever the sample has moved by the width of the line focus (17). In this way, adjacent tightly spaced lines of the sample are excited successively as the sample moves through the field of view, and for each pulse a data set resolved in the sample coordinate x, time t, and wavelength λ is recorded while the sample coordinate y is resolved through the sequence (8) of data sets.

This present invention provides a system that performs FLIM with a photosensor that combines two-dimensional spatial resolution sufficient to produce an image with a time resolution of the order of a nanosecond or better without the need to shutter or otherwise modulate the sensitivity of the sensor.

This system performs FLIM with a photon sensor that is sensitive to the level of individual photons in the visible and near-visible part of the electromagnetic spectrum while producing false “noise” events only at a negligible rate compared to the actual photon rate, and that combines two-dimensional spatial resolution sufficient to produce an image with a time resolution of the order of a nanosecond or better without the need to shutter or otherwise modulate the sensitivity of the sensor.

This system performs THIS, i.e., FLIM with additional hyperspectral resolution, with a photosensor that combines two-dimensional spatial resolution sufficient to produce an image with a wavelength resolution of tens of spectral channels and a time resolution of the order of a nanosecond or better without the need to shutter or otherwise modulate the sensitivity of the sensor.

This system performs THIS, i.e., FLIM with additional hyperspectral resolution, with a photon sensor that is sensitive to the level of individual photons in the visible and near-visible part of the electromagnetic spectrum while producing false “noise” events only at a negligible rate compared to the actual photon rate, and that combines two-dimensional spatial resolution sufficient to produce an image with a wavelength resolution of tens of spectral channels and a time resolution of the order of a nanosecond or better without the need to shutter or otherwise modulate the sensitivity of the sensor.

This system provides a way of multiplexing four-dimensional data into a three-dimensional data stream. Here, the four-dimensional THIS data are multiplexed into a three-dimensional data stream.

The following application example illustrates one specific example of how the present invention can be used in practice. The sample application is in the detection of proteins indicative of a pathogen, specifically here the COVID-19 virus, and of immunity against it. COVID-19 poses a particular challenge in that an unknown, but probably significant, number of infections can go without symptoms. A person who is immune but shows no presence of an active infection most likely had been infected in the past. Knowledge of past infections is important for 1) the tracing of past contacts and quarantining possible disease carriers, 2) epidemiological modeling and 3) also to assess whether a person can safely return to the workforce. The latter aspect is particularly relevant for health-care workers.

The following usage scenarios can be implemented, in order of increasing sensitivity and selectivity with 1) a CUTID sensor in place of one of those currently used in FLIM for faster operation and higher throughput, 2) performing THIS for higher specificity due to the data being present in fully resolved 4-dimensional form instead of a 3-dimensional projection from 4 dimensions as in regular FLIM, 3) performing THIS in conjunction with the use of laser pulses with a particular spectro-temporal profile (aka. Wigner distribution) matched for optimal and highly specific excitation of a particular molecular species of interest. The latter concept is known in chemistry as “coherent control”, and it involves, typically, an empirical search for a Wigner distribution that matches a desired outcome (here excitation to fluorescence) like a key to a lock.

First, to the task of detecting an active infection through the presence of the four structural proteins of the COVID-19 virus, which are known as “spike” (S), “envelope” (E), “membrane” (M), and “nucleocapsid” (N): If any of these proteins are detected in a patient, then this would indicate the presence of viral particles. The procedure will be to first obtain samples of these four proteins from vendors of biochemical reagents. These proteins are synthesized in pure form, and are not extracted from the virus itself. They are thus safe to handle and available in amounts sufficient for laboratory work. Then, specific signal signatures are obtained by placing a small amount of the respective protein sample into a FLIM or THIS apparatus (optionally with coherently-controlled laser excitation), and a “library” of such signatures is compiled. A typical way of sample preparation is to prepare an aqueous suspension of the protein from the dry powder or concentrated suspension obtained from the vendor, and put a small amount onto a nitrocellulose-coated glass slide, which is then inserted into the microscope. Once the library of reference signatures is ready, patient samples, such as mouth swabs, can be inserted into the FLIM/THIS apparatus to test for the presence of such signatures in the patient.

Similarly, a library of FLIM/THIS signatures can be compiled for the non-structural proteins (NSP) of the virus. These are expressed only inside an infected cell, performing various functions that are essential for viral replication. Detection of signatures of these NSP in a patient sample is then an indication of the intensity of the infection itself, as opposed to the mere presence of virus.

It is also possible to obtain synthetic antibodies against the viral proteins. It is then possible to measure how the FLIM/THIS signature changes due to the presence of an antibody. This makes use of a particular strength of FLIM, and, by extension, of THIS, namely that it detects whether a particular molecule is in close proximity to another. In such cases, excitation energy can be transferred from one molecule to the other by a process known as Forster resonant energy transfer (FRET), and the FLIM response changes in characteristic ways. For this reason, FRET-FLIM is a widely used method. Once it is understood how the FLIM/THIS signature of a viral protein changes under exposure to antibodies, one can expose a sample of a purified viral structural protein (S, E, M, N) to patient blood plasma and monitor for changes in their FLIM/THIS response. Human antibodies differ from artificial ones, and possibly also between individuals. It is therefore rather likely that the modified response will not be identical to that obtained from artificial antibodies. However, the mere fact of a changed FLIM/THIS response may be indicative of the presence of antibodies against the viral proteins. Furthermore research may yield characteristic patterns in which the FLIM/THIS response of viral proteins changes due to antibodies. This is quite plausible because antibodies tend to target particular reactive sections of a given antigen (here the viral proteins).

Monitoring Air for Pathogens

Time-resolving Hyperspectral Imaging Spectroscopy (THIS) may also be used in a method to continuously monitor air for pathogens. Here, a high-performance photon detector enables measuring simultaneously the fluorescence time profile and the accompanying spectral shifts.

More specifically, the air that is monitored flows through a zone, which is traversed by a pulsed laser beam. The laser wavelength is chosen for efficient excitation of fluorescence of the molecules of interest, typically in the ultraviolet range, and the pulse duration is much shorter than typical fluorescent lifetimes, which are of the order of a few nanoseconds in the case of protein fluorescence. Although the laser-pulse duration then only needs to be significantly shorter than a nanosecond, it may be practical to use even shorter pulses below a picosecond in order to use industrial fiber lasers and to facilitate the generation of UV light from the infrared laser emission. In order to maximize the interaction of excitation light with the dispersed airborne sample, the laser beam will typically be bounced between mirrors for multiple passes through the sample air. The laser-beam path is imaged onto the sensitive surface of a Continuous Ultrafast Time-resolving Imaging Detection (CUTID) to locate a fluorescent particle in space and time. The geometry of the laser-beam path may take various forms, but in a particular embodiment the laser beams all lie in a plane, parts of which are traced out by different sections of the laser beam. Such a plane shall be called a “light sheet”. In such an embodiment of the invention, the imaging geometry is straightforward from the plane of the light sheet to the plane of the sensitive surface of the detector.

As shown in FIG. 6, an air duct (101) with a pulsed laser beam (102) entering it to be reflected between mirrors (103) and (104) in a multiply-folded path (105) creates a sheet of light spanning the cross section of the air duct (101). The flow (106) of air going through the air duct (101) carries with it particles or molecules of the substance of interest. Fluorescent light generated within the light sheet is imaged (107) by a lens (108) though a window (109) onto a CUTID (110).

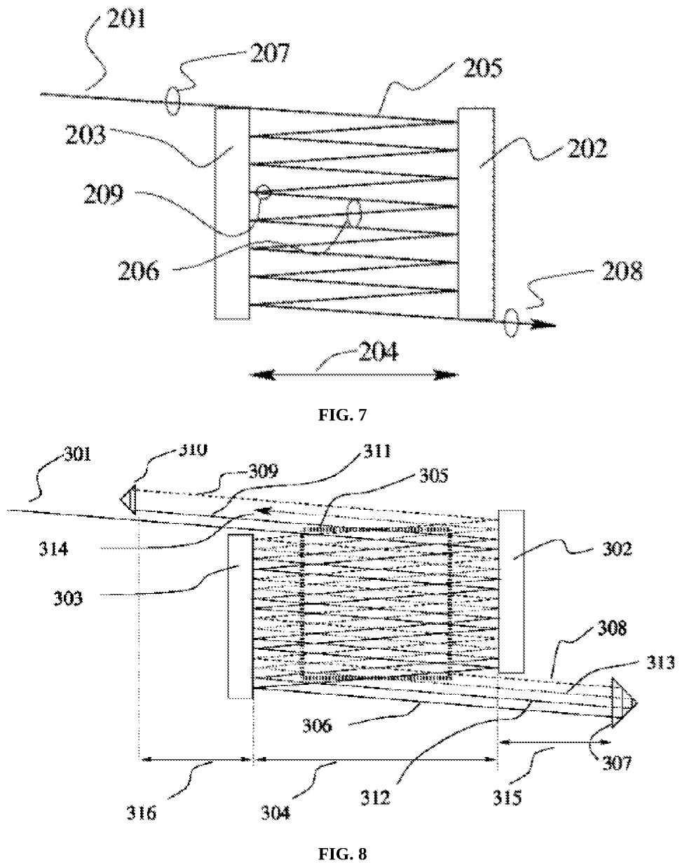

In FIG. 7, an exemplary implementation of the light sheet with specific dimensions given is illustrated. These dimensions are not meant to limit the invention, but only to serve illustrative purposes, such as how the laser-beam diameter varies along the path length under given focusing conditions. The dimensions will likely be different in other embodiments of the invention. A laser beam (201) enters the space between mirrors (202) (203) and is reflected of the order of 100 times. In this specific example, the separation (204) is 20 cm, and thus the path length (205) is about 20 m. The laser beam is mildly focused for a beam waist (206) of 2 mm. At a laser wavelength of 265 nm, the beam diameter at the entrance (207) and the beam diameter at the exit (208), each 10 m from the waist, is about 2.4 mm. In this simple beam geometry, successive beam segments overlap, and molecules in the overlap (209) region are excited twice within the fluorescent lifetime.

In FIG. 8, a modified light path to address the problem of double excitation from adjacent sections of the beam path in FIG. 7 is illustrated. Here, the laser beam (301) enters the region between mirrors (302) (303) and is reflected several times. The separation (304) between the mirrors is wider by a factor of about two than the region of interest (305) to give the reflected laser beams space to separate and not overlap inside the region of interest (305). The reflection angle from the mirrors is chosen such that the laser beams are separated by several times (four times in the case shown in the figure) of their diameter. After several reflections, the laser beam exits (306) the region between the mirrors and is reflected back by a retroreflector (307). The retroreflected beam is antiparallel to, and displaced from, the beam (306) to become beam (308), enters again the region between the mirrors. After, again, several reflections, it exits as beam (309) and is reflected back with displacement by retroreflector (310) to become beam (311), which, upon exiting as beam (312), is retro-reflected as beam (313), enters the region between the mirrors once more to leave as beam (314), and be discarded. This multi-pass arrangement ensures that immediately neighboring sections of the laser beam path are not adjacent with regard to the travel time of the light. Instead, they are separated by, of the order of, ten nanoseconds, which greatly exceeds the fluorescent lifetime of proteins. In other applications where longer fluorescent lifetimes need to accommodated, a longer temporal separation is possible by increasing the distances (315) and (316).

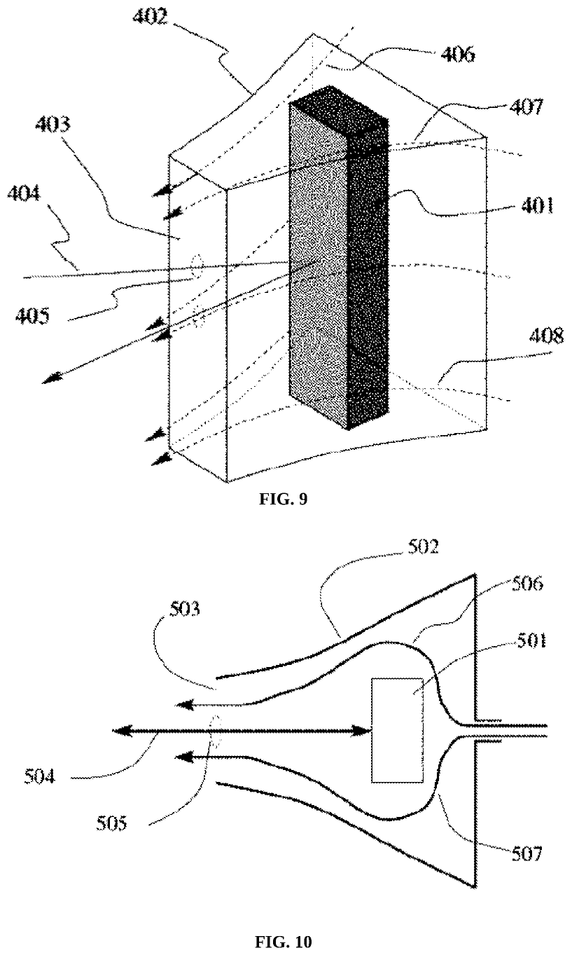

In FIG. 9, a mirror (401) is shown in a position (302) or (303) within an enclosure (402) with an open aperture (403) through which the laser beam (404) enters (405) and leaves the enclosure for each of the multiple reflections. For visual clarity, the places where the laser beam intersects the plane of the aperture (403) is indicated with dotted circles. Filtered and dried air is blown into the enclosure so that it flows (406) (407) (408) past the mirror (401) and out through the aperture (403), thus preventing dust or volatiles that might accumulate on surfaces from reaching the mirror (401).

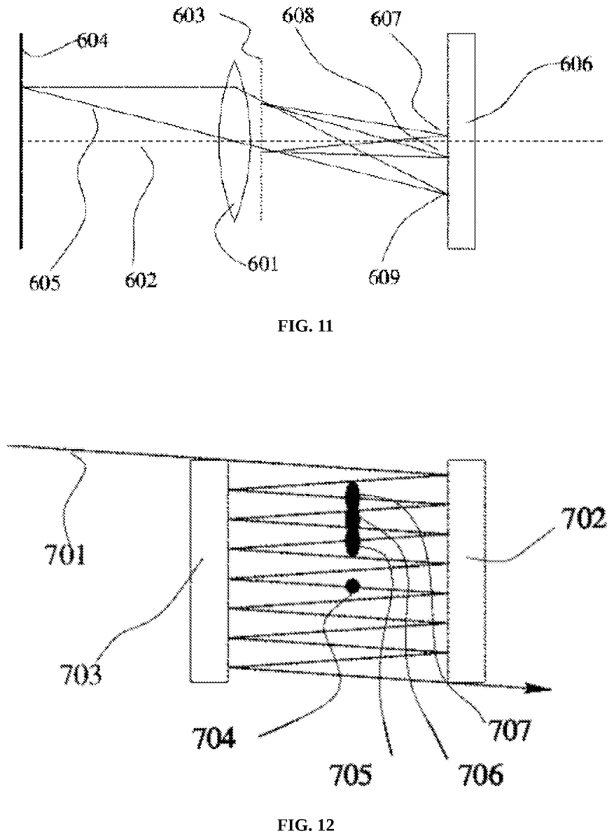

FIG. 10 illustrates a two-dimensional cross-sectional view of the mirror enclosure shown in FIG. 9 in a perspective view. The numerical labels correspond to each other with an offset of 100, so, for example, a label ‘501’ FIG. 10 corresponds to ‘401’ in FIG. 9. The mirrors mirror (501) in positions (302) and (303) are situated in an enclosure (502) with an open aperture (503) through which the laser beam (504) enters (505) and leaves the enclosure for each of the multiple reflections. For visual clarity, a place where the laser beam intersects the plane of the aperture (503) is indicated with a dotted circle. Filtered and dried air is blown into the enclosure so that it flows (506) (507) mirror (501) and out through the aperture (503), thus preventing dust or volatiles that might accumulate on surfaces from reaching the mirror (501).

In FIG. 11, a schematic view of the optics for obtaining wavelength-resolved data is shown, including lens (601) placed on the optical axis (602) defined by the symmetry axis of the lens. A transmission grating (603) is shown right next to the lens. This placement is for illustrative purposes only and shall not be construed as limiting the scope of the invention. As stated above, the optical configuration in a practical embodiment of the invention may vary. Fluorescent light emitted from a location on the light sheet (604) is imaged (605) onto the sensitive surface of a CUTID (606). The transmission grating (603) disperses the light by wavelength, where, as always with optical gratings, longer (607) wavelengths in the first diffraction order are deflected by larger angles than shorter (608) wavelengths. The 0-order diffraction from the grating is not deflected and appears in the same location where an image (609) of the object on the light sheet (604) will appear in the absence of a grating.

FIG. 12 illustrates an image of the optical assembly shown in FIG. 7 on a plane containing the sensitive surface of the CUTID. The line (701) represents an image of the laser beam, i.e., how, for example light scattered from the laser beam would be imaged onto the CUTID. Likewise, images of the mirrors (702) and (703) appear on the image plane outside the sensitive surface of the CUTID. In the image of the light sheet on the CUTID, the 0-th order (704) appears in a location corresponding to the actual location of fluorescence emission within the light sheet, while the spectrally dispersed first order appears in places in the image that correspond to other locations in the light sheet. The shorter (705) wavelengths appear with less displacement from the 0-th order (704); than intermediate (706) or longer (707) ones. The fact that FIG. 12 is based upon the simplified beam path of FIG. 7 shall not imply any constraint on the use of spectral dispersion and THIS in this invention. In a practical embodiment, another beam path, such as the one shown in FIG. 8 may be used.

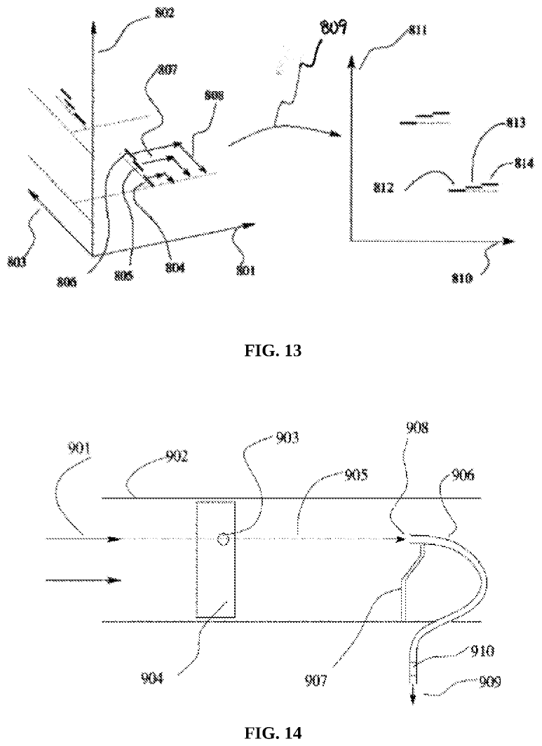

FIG. 13 shows a representation of THIS data in a three-dimensional abstract data space resolved by a one-dimensional location x (801), time t (802), and wavelength λ (803). A fluorescence event produces photons (804), (805), and (806) at different times and different wavelengths, and at one location x within the light sheet. In the first diffraction order of the grating, light of different wavelengths is imaged onto the CUTID at different locations, as shown in FIG. 12. Mathematically, this amounts to the combination of a shearing (807) transformation and a projection (808). In combination, the two form a mapping (809) from the abstract data space onto the data actually recorded by the CUTID in its spatial (810) and temporal (811) coordinates. Photons (804) are thus imaged to appear at different spatial (810) locations on the CUTID as (812), and likewise (805) as (813) and (806) as (814).

This mapping overlays the wavelength coordinate onto a spatial coordinate, but as long as the fluorescent particles are sparse, so that fluorescence patterns do not overlap, there is no ambiguity. In other words, the multiplexing procedure described here is of statistical nature, unlike the deterministic mapping and multiplexing described above.

FIG. 14 illustrates air (901) flowing in a duct (902) carrying with it a particle (903) that fluoresces in the light sheet (904), which is set at an angle relative to the air duct, and is seen in the figure in a side on view. Because of the laminar flow (905), of the air at a known velocity, a suction hose (906), can be positioned with an actuator (907), in time for arrival (908). Just before the anticipated arrival of the particle at the entrance of the suction hose, air is pulled (909) into it and the particle is trapped in a filter (910).

The invention described above provides a system for performing Fluorescence Lifetime Spectroscopy (FLS) with an imaging photosensor that acquires time-resolved light-intensity data continuously, i.e., without needing a shutter, time gate, or other type of sensitivity modulation, and with a time resolution sufficient to resolve all features of interest in the decay curve. In the case of protein fluorescence, for example, this requires an ultrafast resolution of better than one nanosecond.

The system that has two-dimensional spatial resolution, i.e., imaging capability, in combination with the ultra-fast time resolution specified above separately and independently at each image location. Such a detector shall be called a Continuously-operating Ultrafast-Timing Imaging Detector (CUTID).

The system performs FLS with two-dimensional spatial resolution and ultrafast time resolution at a sensitivity level of individual photons in the visible and neighboring parts (UV and IR) of the electromagnetic spectrum while false “noise” events occur only at a negligible rate compared to the actual photon rate.

The system performs THIS, i.e., FLS with additional hyperspectral resolution in an image.

The system that performs THIS with 2-dimensional spatial and continuous ultrafast time resolution.

The system performs THIS with 2-dimensional spatial and continuous ultrafast time resolution at a sensitivity level of individual photons in the visible and neighboring parts of the electromagnetic spectrum while false “noise” events occur only at a negligible rate compared to the actual photon rate.

The system applies a correction to each sample location for the time the excitation light needs to reach that location and for the fluorescence light to go from there to the detector. Such corrections become necessary in ultrafast timing measurements whenever geometric light-path differences lead to timing effects due to the limited speed of light of 0.3 mm per picosecond.

The system continuously monitors the air flowing in a duct for the presence of certain molecules of interest, such as proteins indicative of pathogens, based on FLS or THIS.

The system multiplexes higher-dimensional sparse data into a lower-dimensional dense data stream. Specifically here, four-dimensional THIS data (2D image, time and wavelength) are to be multiplexed into a three-dimensional data stream.

The system provides information about the time and location of a detected particle to a targeted capture device that obtains a sample containing this particle for further analysis.

Precision Optical Spectroscopy in a Mass Spectrometer

Time-resolving Hyperspectral Imaging Spectroscopy (THIS) may also be used in conjunction with a mass spectrometer. Here, a combination of a mass spectrometer with optical spectroscopy provides a way of doing precision optical spectroscopy on molecular ions in a mass spectrometer.

At the core of the invention is the combination of mass spectrometry with optical spectroscopy to provide detailed optical-spectroscopic information on the molecular species present in the mass spectrum while obtaining un-mixed optical spectra from molecular species pre-sorted through the mass spectrometer.

In an embodiment, a mass-selecting device, such as a quadrupole mass spectrometer directs a beam of molecules or particles of a particular mass through an electrical retardation field that slows the molecules to approximately room-temperature thermal velocity, i.e., the average velocity that a molecule of such a mass would have while mixed into an ideal gas at room temperature. The electric field whose strength can be calculated from the known mass/charge ratio of the selected molecules/particles terminates at the surface of a substrate onto which the molecules/particles are deposited. The selection properties of the mass-selecting device are tuned as the substrate is moved laterally with respect to the incident molecular beam, so that adjacent spots on the latter receive molecules at various mass tunes of the mass selector. Once the deposition process is completed, the substrate is moved to a spectroscopy site, or spectroscopy is performed in place.

In the above, the optical method of Time-resolved Hyperspectral Spectroscopy (THS) is combined with the mass spectrometer, using an imaging-capable ultrafast photon detector with a time resolution sufficient for the pertinent time-dependent features in the fluorescence, i.e., a CUTID. In the case of protein fluorescence with decay times of a few nanoseconds, the detector has to resolve at least to one nanosecond, and preferably to about 100 picoseconds or better. The row of adjacent spots on the substrate containing different-mass molecular species is imaged onto the detector via a wavelength dispersive element, such as a reflection grating. This spreads, dispersed by wavelength, the one dimensional image of the row of spots on the substrate into an orthogonal dimension. Thus, one image dimension of the detector is given to resolving the spots on the substrate where sample molecules were deposited. The other image dimension is given to the dispersed wavelength spectrum, and photon occurrence time relative to the excitation-laser pulses is obtained directly from the detector time resolution.

In another embodiment, the mass spectrometer separates the molecular species over a spatial coordinate by their mass/charge ratio. This can be done, for example, by deflecting a beam of molecular ions in an electrostatic field, so that the molecules fan out with the heaviest ones (highest mass/charge ratio) being deflected the least. After fanning out, the ions are slowed by an electric retardation field and then deposited onto a substrate. Spectroscopic analysis then proceeds.

In another embodiment, the mass spectrometer separates the molecular species in time, for example by generating a cluster of them within a short time, then accelerating them in an electrostatic field to a particular kinetic energy, and letting them continue their trajectories for some distance. While “drifting”, the lighter (lower mass/charge ratio) molecular ions increasingly get ahead of the heavier (higher mass/charge ratio) ones. A pulsed laser that is co- or counterpropagating with the molecular beam excites the molecular ions to fluorescence. The fluorescence is observed in the same way as previously described, except for the fact that the molecules are now not fixed on a substrate, but at deterministically time-dependent positions along the beam. Each mass fraction in the molecular beam, which is characterized, through its velocity, by a particular time-dependent position along the beam axis can be excited multiple times by successive laser pulses. Correlating fluorescence signals from successive laser pulses improves the signal statistics. As discussed above, there are two distinctly different timescales: one is the microsceond-millisecond mass-spectroscopic time scale, which is given by the duration of the drift and transit of the molecules through the zone where they interact with the laser. The other is the optical-spectroscopic time scale of fluorescence decay, which is typically much faster, for example a few nanoseconds in the case of proteins. Therefore, samples of the molecular beam at successively higher mass/charge ratios can be sampled with successive excitation pulses, and the full fluorescence process following each will occur within a small fraction of the mass-spectroscopic time scale. At each instant of mass-spectroscopic time, an image of the one-dimensional beam, dispersed by wave-length then forms a two dimensional image, over image coordinates that correspond to mass, and to a wavelength.

In another embodiment, the ions caught in a trapping-type mass spectrometer, such as the Orbitrap, undergo periodic motions in closed orbits with periods proportional to the square root of their respective mass/charge ratios. Image currents from the ions that are induced in the outer shell of the Orbitrap are picked up by a differential amplifier. The total image current is a superposition of the image currents due to the individual orbiting mass fractions. This superposition is resolved into frequency (reciprocal to the orbital periods) components in a Fourier transform, so that, finally, the amounts of orbiting mass fractions appear as peaks over the mass axis. While the ions are orbiting, they can also be excited to fluorescence from a pulsed laser beam passing through the Orbitrap. The fluorescent light from the linear laser-beam track is imaged onto a CUTID with a dispersive element generating a spectrum. As described above, wavelengths and times after laser excitation are obtained from the detector output. In this embodiment, the spatial coordinate along the laser-beam track does not have a direct meaning referring to masses, as it had in the previously described embodiments. It can, however, be used to identify features in the mass distribution along an orbit tangential to the laser beam by correlating photon occurrences from successive laser pulses at locations along the laser track. Just as the raw signal of the image current is a superposition of components relating to individual mass fractions, so are the fluorescence data. The only difference is that the current is a scalar quantity, i.e., zero-dimensional data over the time axis, and the fluorescence data comprise two-dimensional data (photon-occurrence times after laser excitation and wavelengths) over time. Both can be resolved into components relating to individual molecular mass fractions by the use of the Fourier transformation. As discussed above, there are two time scales: one in the mass-spectroscopic time corresponding to orbital periods measured in microseconds, and the other is the spectroscopic time scale of fluorescent decay measured in nanoseconds. It is therefore possible to perform many optical-spectroscopic measurements within one orbital period and to multiplex the optical-spectroscopic time scale onto the time axis between orbital repetitions.

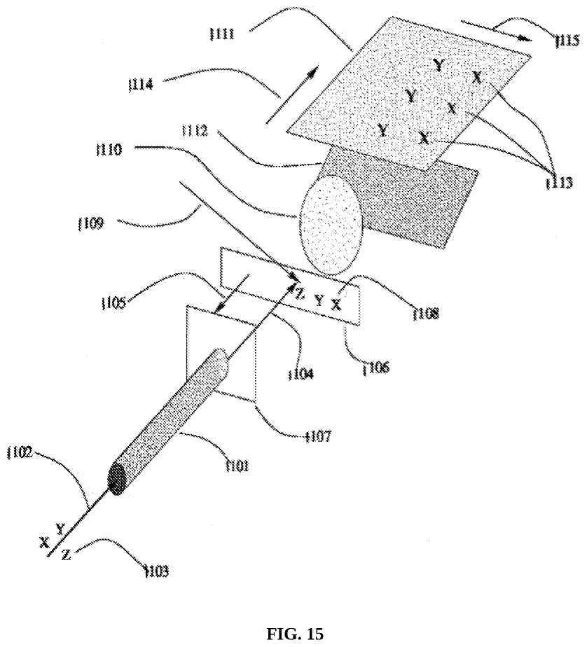

Turning now to FIG. 15, a mass-selecting mass spectrometer (1101) is shown with a molecular-ion beam (1102) containing multiple molecular species X, Y, Z (1103). Exiting the mass spectrometer is a molecular beam (1104) containing only molecules within a narrow range of mass/charge ratios, depending on the tune of the mass spectrometer. The molecules are slowed down by an electric field (1105) between a substrate (1106) and the exit (1107) plane of the mass spectrometer. The electric field (1105) is set to a strength that slows the molecular beam to approximately thermal velocity as it hits the substrate (1106). The substrate (1106) is moved laterally as the setting for transmitted masses in the mass spectrometer (1101) is changed in a way to sample all masses of interest. In this way, different mass fractions present in the original molecular-ion beam (1102) are deposited in adjacent positions (1108) on the substrate (1106). A pulsed laser beam (1109) excites the sample molecules on the substrate (1106) to fluorescence, and the fluorescent light is imaged by a lens (1110) or, generally, an imaging optical system onto an imaging-capable ultrafast time-resolving photon detector (1111) such as the LAPPD. Part of the imaging system is a wavelength-dispersive element, such as a diffraction grating (1112), which sends different wavelengths of fluorescent light to different locations (1113), along the wavelength coordinate (1114) on the photon detector (1111). The other spatial coordinate on the photon detector (1111) will be called the mass coordinate (1115) because it corresponds to the locations on the substrate (1106) holding different mass fractions of sample molecules.

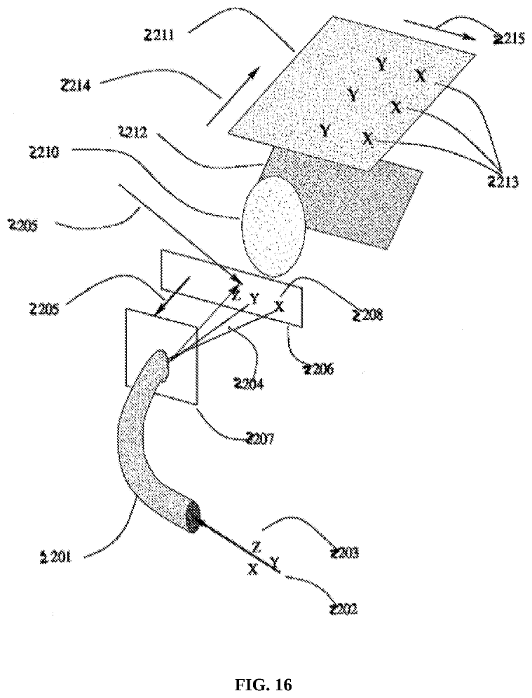

In FIG. 16, a mass-dispersing mass spectrometer (2201) with a molecular-ion beam (2202) is shown containing multiple molecular species X, Y, Z (2203). Exiting the mass spectrometer are fanned-out molecular beams (2204) where each angle in the fan contains a particular mass/charge ratio. The molecules are slowed down by an electric field (2205) between a substrate (2206) and the exit (2207) plane of the mass spectrometer. The electric field (2205) is set to a strength that slows the molecular beams in the fan to approximately thermal velocity as they hit the substrate (2206). In this way, different mass fractions present in the original molecular-ion beam (2202) are deposited in adjacent positions (2208) on the substrate (2206). A pulsed laser beam (2209) excites the sample molecules on the substrate (2206) to fluorescence, and the fluorescent light is imaged by a lens (2210) or, generally, an imaging optical system onto an imaging-capable ultrafast time-resolving photon detector (2211) such as the LAPPD. Part of the imaging system is a wavelength-dispersive element, such as a diffraction grating (2212), which sends different wavelengths of fluorescent light to different locations (2213), along the wavelength coordinate (2214) on the photon detector (2211). The other spatial coordinate on the photon detector (2211) will be called the mass coordinate (2215) because it corresponds to the locations on the substrate (2206) holding different mass fractions of sample molecules.

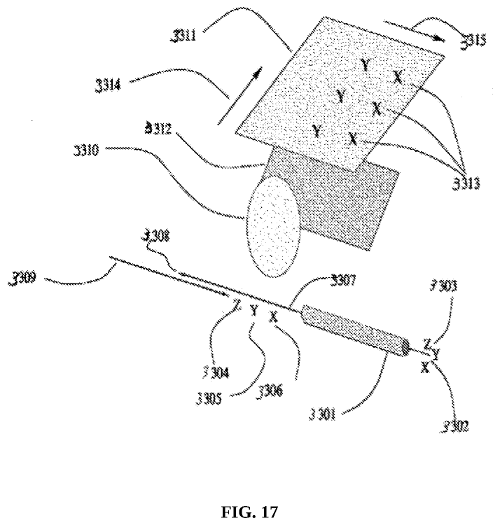

FIG. 17 shows a time-of-flight mass spectrometer (3301) where pulsed bunches of molecular/particulate ions (3302) containing multiple molecular/particulate species X, Y, Z (3303) enter an acceleration- and beam-forming section of the mass spectrometer (3301). After acceleration, the molecular beam “drifts” freely, and the lighter (3304) (lower mass/charge ratio) ions increasingly get ahead of the intermediate mass (3305), and the heavier (3306) ones, so that they are all strung out by mass along the beam axis. The ions continue to a beam dump (3308) where a conventional molecular detector, such as a micro channel plate or a channeltron may be situated. A pulsed laser beam (3309) beam co- or counterpropagating with the molecular beam excites the sample molecules to fluorescence, and the fluorescent light is imaged by a lens (3310) or, generally, an imaging optical system onto an imaging capable ultrafast time-resolving photon detector (3311) such as the LAPPD. Part of the imaging system is a wavelength-dispersive element, such as a diffraction grating (3312), which sends different wavelengths of fluorescent light to different locations (3313), along the wavelength coordinate (3314) on the photon detector (3311). The other spatial coordinate on the photon detector (3311) will be called the mass coordinate (3315) because it corresponds to the time-variable locations along the molecular beam (3307) holding different mass fractions of sample molecules.

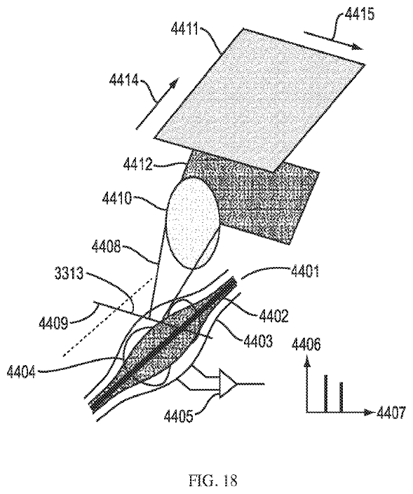

FIG. 18 shows an Orbitrap mass spectrometer (4401) consisting of an inner electrode (4402) and an outer electrode (4403) at different electrical potentials. A molecular or particulate ion is trapped between these two electrodes in a closed orbit (4404), which repeats at a period given by the square root of its mass/charge ratio. The charge of the ion induces an image current in the outer electrode (4403), which is measured with a differential amplifier (4405). The orbital periods, and thus the masses of different molecular and particulate species are found as intensity (4406) peaks over the mass axis (4407) in a Fourier transform of the image current with respect to time. The fluorescent light (4408) from trapped ions intercepting a fluorescence-exciting pulsed laser beam (4409) beam is imaged by a lens (4410) or, generally, an imaging optical system onto an imaging-capable ultrafast time resolving photon detector (4411) such as the LAPPD. Part of the imaging system is a wavelength dispersive element, such as a diffraction grating (4412), which sends different wavelengths of fluorescent light to different locations along the wavelength coordinate (4414) on the photon detector (4411). The other spatial coordinate on the photon detector (4411) will be called the orbit coordinate (4415) because it corresponds to the time-variable locations along the closed orbit (4404). Resolution along this coordinate can be used for improvement of measurement statistics through correlations between fluorescence measurements from successive laser pulses. By changing the angle (4413) between the pulsed laser beam (4409) and the symmetry axis of the Orbitrap device, ions in particular orbits can be excited preferentially.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A method of fluorescence spectroscopy comprising:
providing a high-performance sensor that combines imaging with high intrinsic time resolution and high-rate capability; and
resolving fluorescence data in four dimensions.

2. The method of claim 1 wherein the four dimensions are 2D image, time, and wavelength spectrum.

3. The method of claim 2 wherein the high-performance sensor is a photon sensor that provides a continuous data stream of time- and image-location-tagged photon-detection events.

4. The method of claim 3 wherein the high-performance sensor is a Continuous Ultrafast Time-resolving Imaging Detector.

5. The method of claim 4 wherein the Continuous Ultrafast Time-resolving Imaging Detector is Large-Area Picosecond Photodetector.

6. The method of claim 2 further comprising multiplexing one out of four data dimensions onto the time dimension.

7. A method for rapidly performing a Fluorescence-Lifetime Imaging Microscopy measurement comprising:
engaging a sensor that delivers a continuous data stream of time-and-location-tagged light detection events, and at a high rate of many light-detection events within the fluorescent lifetime of the molecular species of interest.

8. The method of claim 7 wherein the sensor has a sensitivity for detecting individual photons.

9. The method of claim 8 wherein the sensor has noise events at a rate significantly below a rate of true photon events.

10. A system for performing imaging spectroscopy comprising:
a detection sensor configured for detecting and providing a multi-dimensional data stream of time-tagged, location-tagged and/or wavelength-tagged detection events.

11. The system of claim 10 wherein the detection sensor is configured to provide a continuous data stream without time-gating or otherwise modulating a light sensitivity of the detection sensor.

12. The system of claim 11 wherein the detection sensor configured for detecting, measuring and/or resolving a time dependence and/or a wavelength dependence of the data stream, following pulsed, or otherwise modulated optical excitation.

13. The system of claim 12 wherein the detection sensor is a two-dimensional detection sensor.

14. The system of claim 13 wherein the detection sensor is a Continuous Ultrafast Time-resolving Imaging Detection (CUTID) sensor.

15. The system of claim 14 wherein the Continuous Ultrafast Time-resolving Imaging Detection sensor is a Large-Area Picosecond Photodetector (LAPPD).

16. A system comprising:
an air duct for channeling a flow of air, the air comprising particles of a substance of interest;
a pulsed laser beam configured to reflect off a pair of mirrors in a multiply-folded path that produces a sheet of light spanning a cross-section of the air duct;
a lens; and
a window, wherein fluorescent light generated within the sheet of light is imaged by the lens through the window onto a continuously-operating ultrafast-timing imaging detector with single-photon sensitivity in a visible and neighboring ultraviolet and infrared spectral regions.

17. The system of claim 16 wherein the continuously-operating ultrafast-timing imaging detector comprises a large-area picosecond photodetector.

18. A method comprising:
performing Fluorescence-Lifetime-Spectroscopy (FLS) measurements with a time-resolving imaging sensor continuously without time-gating or otherwise modulating a light sensitivity of the imaging sensor.

19. The method of claim 18 wherein the imaging sensor is configured to provide a time resolution sufficient to resolve a fluorescence-decay curve of molecules of interest and the time resolution independently at each image location.

20. The method of claim 19 imaging sensor comprises sensitivity for detecting individual photons with noise events at a rate below a rate of true photon events.

21. A method comprising:
providing a mass-dispersing mass spectrometer;
introducing a molecular-ion beam containing multiple molecular species to the mass-dispersing mass spectrometer;
releasing fanned-out molecular beams from the mass-dispersing mass spectrometer, each of the fanned-out molecular beams containing a particular mass/charge ratio; and
applying an electric field between a substrate and an exit plane of the mass-dispersing mass spectrometer to slow down the fanned-out molecular beams.

22. The method of claim 21 further comprising:
setting the electric field to a strength that slows the fanned-out molecular beams to approximately thermal velocity as the hit the substrate, causing different mass fractions present in fanned-out molecular-ion beam to be deposited in adjacent positions on the substrate;
exciting the molecular species on the substrate to fluorescence with a pulsed laser beam; and
imaging the fluorescent light by a lens onto an imaging-capable ultrafast time-resolving photon detector.

23. The method of claim 22 wherein the imaging-capable ultrafast time-resolving photon detector comprises a large area picosecond photodetector.
